(19) United States
(12) Patent Application Publication
(10) Pub. No.: US 2015/0168729 A1
(43) Pub. Date: Jun. 18, 2015

(54) HEAD MOUNTED DISPLAY DEVICE

(71) Applicant: SEIKO EPSON CORPORATION, Tokyo (JP)

(72) Inventor: Shinichi KOBAYASHI, Azumino-shi (JP)

(21) Appl. No.: 14/560,439

(22) Filed: Dec. 4, 2014

(30) Foreign Application Priority Data
Dec. 17, 2013 (JP) 2013-259740

(51) Int. Cl. G02B 27/01; G06F 3/01; G06T 19/00

(52) U.S. Cl. CPC G02B 27/0172; G02B 27/0101; G06T 19/006; G06F 3/013; G02B 2027/0138; G02B 2027/014

(57) ABSTRACT

A head mounted display sets a display status by a user via a display status setting table for virtual display of a virtual image corresponding to an imaged image imaged by a camera (real image) as a camera preview. Then, image data necessary for virtual display of the camera preview in response to the set display status is formed, and the camera preview is virtually displayed in a virtual image display range in the set display status.

### BACKGROUND

1. Technical Field

The present invention relates to a head mounted display device.

2. Related Art

Head mounted display devices (head mounted displays, HMDs) as display devices worn on heads have been known. For example, the head mounted display device generates image light representing an image using a liquid crystal display and a light source, guides the generated image light to an eye of a user using a projection optical system, a light guide plate, etc. and thereby, allows the user to visually recognize a virtual image (for example, Patent Document 1 (JP-A-2013-178639)). In the Patent Document, a technique of realizing augmented reality (AR) for additionally presenting information to a reality environment using a computer is applied, however, not limited to the application of AR. In a head mounted display device with a camera, for a user to visually recognize a virtual image superimposed on an outside scenery, an imaged image imaged by the camera may be previewed as a virtual image. Now, imaged images of cameras are generally previewed in other imaging devices than the head mounted display device. For example, a technique of switching the imaging mode of the camera between a normal mode and a manner mode and, in the manner mode, displaying a preview image reduced to be smaller than that in the normal mode has been proposed (For example, Patent Document 2 (JP-A-2013-115722)).

In the case where an imaged image of a camera is previewed as a virtual image in a head mounted display device with camera not limited to the device in Patent Document 1, as proposed in Patent Document 2, the imaged image of the camera as the virtual image may be reduced and previewed or previewed in a whole virtual image display range. However, the head mounted display device has a peculiar function of allowing a user to visually recognize a preview image as a virtual image superposed on an outside scenery, and the following problems have been pointed out.

When the imaged image of the camera is previewed as a virtual image, the user visually recognizes both an outside scenery of the virtual image as the imaged image and a real outside scenery seen by the user with own eyes at the same time. The imaging range of the camera does not necessarily coincide with the visual recognition range seen by the user with the eyes, and the imaging direction of the camera does not necessarily coincide with the eye line direction of the user. Further, image data of the imaged image is subjected to various kinds of data processing relating to virtual image formation, and the outside scenery of the virtual image as the imaged image is provided with a delay. As a result, mismatch may occur between the outside scenery provided as the virtual image and the real outside scenery and give a feeling of strangeness to the user. The feeling of strangeness due to the mismatch may be significant only by reduction and preview of the imaged image of the camera as the virtual image. Note that, in the case where the user is allowed to visually recognize image data different from that of the imaged image of the camera, e.g., video image data externally provided or possessed by the head mounted display device itself as a virtual image superimposed on an outside scenery, the user acknowledges that the virtual image and the outside scenery are different in the first place, and the feeling of strangeness is less problematic.

Furthermore, it is assumed that the user wearing the head mounted display device uses the camera attached to the device not only for simple imaging of the outside scenery but also for various applications. For example, the camera attached to the device may be used for reading information of a barcode having information in the horizontal direction and a QR code (registered trademark) having information in the vertical and horizontal directions. In this case, the user may dare to desire comparison between the code actually and visually recognized by the user and the code imaged by the camera (specifically, the virtually displayed code), and room for improvement in convenience is left. For the reason, in the head mounted display device with camera, relaxation of the feeling of strangeness when the imaged image of the camera is provided as the virtual image and improvement in convenience have been demanded. In addition, regarding the configuration for providing the imaged image of the camera as the virtual image, improvement in versatility, cost reduction, etc. are desired.

### SUMMARY

An advantage of some aspects of the invention is to solve at least a part of the problems described above, and the invention can be implemented as the following aspects.

(1) An aspect of the invention provides a head mounted display device. The head mounted display device is a head mounted display device that enables visual recognition of a virtual image superimposed on an outside scenery, including an image display unit that forms and displays the virtual image to be visually recognized by a user, a virtual image formation processing unit that executes virtual image formation processing in the image display unit, a camera that can perform imaging in a line-of-sight direction of the user; and a preview setting unit that sets an image display status when an imaged image imaged by the camera is virtually displayed as a preview image in the image display unit. According to the head mounted display device of the aspect, the preview setting unit may set different display statuses, and thereby, may virtually display the imaged image of the camera as the preview image in the image display unit in various statuses through the virtual image formation processing by the virtual image formation processing unit in response to the respective display statuses. For example, the preview image may be provided in a display status in which the imaged image of the camera virtually displayed as the preview image matches with the real outside scenery as close as possible, and the preview image may be provided in a display status in which the imaged image of the camera virtually displayed as the preview image may be compared with the real outside scenery. As a result, according to the head mounted display device of the aspect, in the head mounted display device with camera, the feeling of strangeness when the imaged image of the camera is provided as the virtual image may be relaxed and the convenience may be improved.

(2) In the head mounted display device according to the aspect described above, the preview setting unit may set at least one of a display size of the preview image, a display location of the preview image in a virtual image display range, and a scaling factor when the imaged image is used as the preview image. According to the configuration, the status in which the imaged image of the camera is virtually displayed as the preview image in the image display unit may be further diversified, and the feeling of strangeness due to mismatch with the real outside scenery may be further relaxed and the convenience may be improved.

(3) In the head mounted display device according to the aspect described above, the preview setting unit may wait for settings of the image display status by the user. According to the configuration, the image display status may be variously set through the settings by the user to whom the imaged image of the camera is provided as the preview image as the virtual display, and thereby, the feeling of strangeness due to mismatch with the real outside scenery may be further relaxed and the convenience may be further improved.

(4) In the head mounted display device according to the aspect described above, an option setting operation unit displaying a plurality of setting options with respect to each image display status and operated by the user for selection of the displayed setting options is provided, and the preview setting unit may set the image display status by a user operation of the option setting operation unit. According to the configuration, the user to whom the imaged image of the camera is provided as the preview image as the virtual display may variously set the image display status by selecting a desired setting option from the displayed plurality of setting options, and thereby, the feeling of strangeness due to mismatch with the real outside scenery may be further relaxed and the convenience may be further improved.

(5) In the head mounted display device according to the aspect described above, a display setting operation unit operated by the user when one of a setting of displaying the preview image and a setting of not displaying the image is determined is provided, and the preview setting unit may set the image display status by a user operation of the option setting operation unit when the setting of displaying the preview image is made by a user operation of the display setting operation unit. According to the configuration, the preview image is displayed through the operation of the display setting operation unit by the user who desires display of the preview image, and the configuration is useful for reduction of the feeling of strangeness etc.

(6) In the head mounted display device according to the aspect described above, a display setting unit that monitors a behavior of a head of the user, and makes the setting of displaying the preview image when the user makes a predetermined head behavior is provided, and the preview setting unit may set the image display status by a user operation of the option setting operation unit when the display setting unit makes the setting of displaying the preview image. According to the configuration, the preview image is displayed through the predetermined head behavior made by the user who desires display of the preview image, and the configuration is useful for reduction of the feeling of strangeness etc.

(7) In the head mounted display device according to the aspect described above, a mode switching unit for the user to switch an imaging status by the camera to one of a still image imaging mode and a video imaging mode is provided, and the preview setting unit may set the image display status by a user operation of the option setting operation unit when the mode switching unit switches to the still image imaging mode. Even when the camera image imaged in the still image imaging mode mismatches with the outside scenery visually recognized by the user, the image is the still image desired by the user and imaged, and the user knows the feeling of strangeness due to the mismatch with the real outside scenery and is harder to have the feeling of strangeness.

(8) In the head mounted display device according to the aspect described above, the virtual image formation processing unit may execute the virtual image formation processing so that the preview image may be displayed on the image display unit over a predetermined time. According to the configuration, even when the preview image is displayed, the display time is limited to an initial predetermined time, and thereby, the time in which the feeling of strangeness can be given may be limited.

Not all of the plurality of component elements of the above described respective aspects of the invention are essential. In order to solve part or all of the above described problems or in order to achieve part or all of the advantages described in the specification, some component elements of the plurality of the component elements may be appropriately changed, deleted, replaced by new component elements, partially deleted in limitations. Further, in order to solve part or all of the above described problems or in order to achieve part or all of the advantages described in the specification, part or all of the technical features contained in the above described one aspect of the invention may be combined with part or all of the technical features contained in the above described other aspects of the invention into one independent aspect of the invention.

The invention may be implemented in various aspects. For example, the invention may be implemented in forms of a method of controlling a head mounted display device, a head mounted display system, a computer program for implementation of functions of the method, the device, or the system, a recording medium recording the computer program, etc.

### BRIEF DESCRIPTION OF THE DRAWINGS

The invention will be described with reference to the accompanying drawings, wherein like numbers reference like elements.

FIG. 1 is an explanatory diagram showing a schematic configuration of a head mounted display device in one embodiment of the invention.

FIG. 2 is a block diagram functionally showing a configuration of the head mounted display 100.

FIG. 3 is an explanatory diagram showing image lights output by an image light generation part in a right display drive part 22.

FIG. 4 is an explanatory diagram showing an example of a virtual image formed to be recognized by a user in a generation part 143, a preview control part 141, etc.

FIG. 5 is an explanatory diagram schematically showing a relationship among a visual range VR of the user and an imaging range CRv of a camera 61 and a virtual image display range VIR.

FIG. 6 is an explanatory diagram showing settings of a display size of a preview image containing a virtual image VI corresponding to an imaged image of the camera 61 etc.

FIG. 7 is an explanatory diagram for explanation of an outline of camera preview processing executed in a control unit 10 including an image processing part 160, a display control part 190, etc.

FIG. 8 is an explanatory diagram showing schematic display formats when a camera preview PrV is unnecessary.

FIG. 9 is an explanatory diagram schematically showing examples of display formats when the camera preview PrV is performed.

FIG. 10 is an explanatory diagram schematically showing a display format when a display location of the camera preview PrV is set in an upper right area of the virtual image display range VIR by a user operation.

FIG. 11 is an explanatory diagram schematically showing a display format when a display location of the camera preview PrV is set in an upper left area of the virtual image display range VIR and a display size is set to 960×540 by a user operation.

FIG. 12 is an explanatory diagram schematically showing a display format when a display location of the camera preview PrV is set in an upper right area of the virtual image display range VIR and a display scaling factor is set to 2.0 by a user operation.

FIGS. 13A and 13B are explanatory diagrams showing outer configurations of head mounted displays in modified examples.

### DESCRIPTION OF EXEMPLARY EMBODIMENTS

### A. Embodiment

### A-1. Configuration of Head Mounted Display Device:

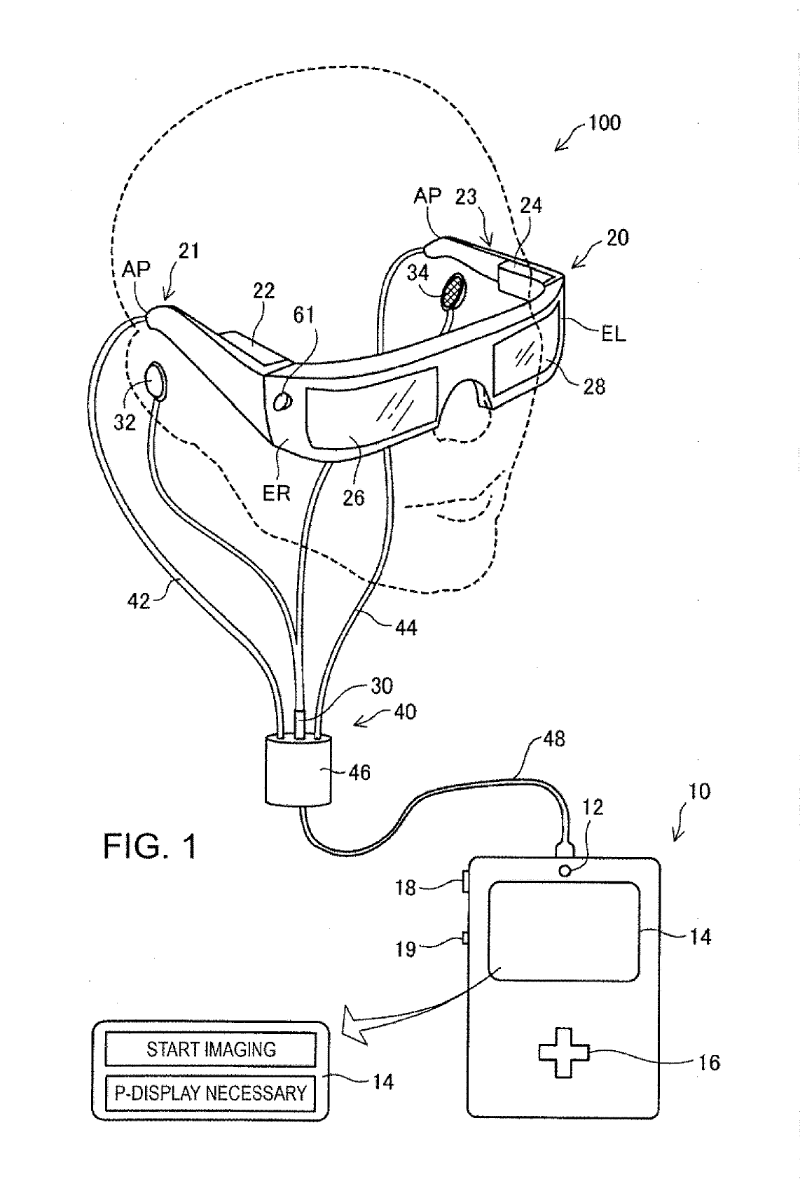

FIG. 1 is an explanatory diagram showing a schematic configuration of a head mounted display device in one embodiment of the invention. The head mounted display device 100 is a display device worn on a head and also called a head mounted display (hereinafter, “head mounted display 100”). The head mounted display 100 of the embodiment is an optically-transmissive head mounted display device that enables visual recognition of a virtual image and direct visual recognition of outside scenery.

The head mounted display 100 includes an image display unit 20 allows the user to visually recognize a virtual image when worn on a head of a user, and a control unit (controller) 10 that controls the image display unit 20.

The image display unit 20 is a wearable unit worn on the head of the user and has a spectacle shape in the embodiment. The image display unit 20 includes a right holding part 21, a right display drive part 22, a left holding part 23, a left display drive part 24, a right optical image display part 26, a left optical image display part 28, and a camera 61. The right optical image display part 26 and the left optical image display part 28 are provided to be located in front of the right and left eyes of the user when the user wears the image display unit 20, respectively. One end of the right optical image display part 26 and one end of the left optical image display part 28 are connected to each other in a location corresponding to the glabella of the user when the user wears the image display unit 20.

The right holding part 21 is a member provided to extend from an end part ER as the other end of the right optical image display part 26 to the location corresponding to the temporal part of the user when the user wears the image display unit 20. Similarly, the left holding part 23 is a member provided to extend from an end part EL as the other end of the left optical image display part 28 to the location corresponding to the temporal part of the user when the user wears the image display unit 20. The right holding part 21 and the left holding part 23 hold the image display unit 20 on the head of the user like temples of spectacles.

The right display drive part 22 is provided inside the right holding part 21, in other words, at the sides opposed to the head of the user when the user wears the image display unit 20. The left display drive part 24 is provided inside the left holding part 23. Note that, as below, the right holding part 21 and the left holding part 23 are also collectively and simply referred to as “holding parts”, the right display drive part 22 and the left display drive part 24 are also collectively and simply referred to as “display drive parts”, and the right optical image display part 26 and the left optical image display part 28 are also collectively and simply referred to as “optical image display parts”.

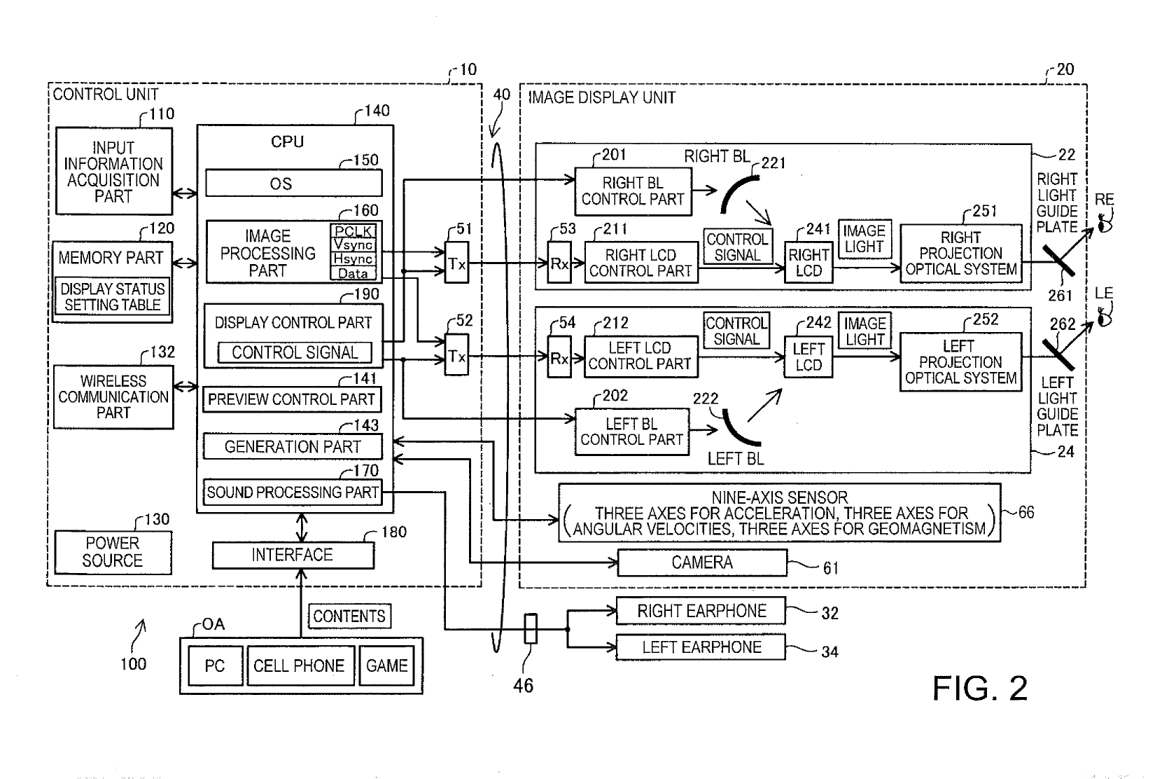

The right and left display drive parts include liquid crystal displays (hereinafter, referred to as “LCDs”) 241, 242, and projection optical systems 251, 252, and the like (see FIG. 2). The details of the configurations of the display drive parts will be described later. The optical image display parts as optical members include light guide plates 261, 262 (see FIG. 2) and dimming plates. The light guide plates 261, 262 are formed, using a light-transmissive resin material or the like and guide image lights output from the display drive parts to the eyes of the user. The dimming plates are optical devices having thin plate shapes and provided to cover the front side of the image display unit 20 (the opposite side to the side of the user's eyes). The dimming plates protect the light guide plates 261, 262 and suppress damage, attachment of dirt, or the like to the light guide plates 261, 262. Further, by adjustment of light transmittance of the dimming plates, the amount of outside light entering the user's eyes may be adjusted and the ease of visual recognition of the virtual image may be adjusted. Note that the dimming plates are dispensable.

The camera 61 is provided in the end part ER of the image display unit 20 when the user wears the image display unit 20. The camera 61 is set in an imaging direction in the anterior direction of the image display unit 20, in other words, a line-of-sight direction of the user when the user wears the head mounted display 100, images an outside scenery (a scenery of the outside) in front of the user in the imaging direction, and acquires an outside scenery image. In this case, when the user wearing the head mounted display 100 moves the head vertically and horizontally, the line-of-sight direction of the user changes according to the motion and the imaging direction of the camera 61 also changes. The camera 61 is the so-called visible light camera, and includes an image sensing device such as a CCD (Charge Coupled Device), a CMOS (Complementary Metal-Oxide Semiconductor), or the like. The outside scenery image acquired by the camera 61 is an image representing a shape of an object from visible light radiated from the object, and the imaging data is output to a CPU 140, which will be described later, and used for virtual image formation processing, which will be described later. The camera 61 in the embodiment is a monocular camera, or may be a stereo camera. In addition, it is only necessary that the camera 61 may perform imaging in the line-of-sight direction of the user, and may be a camera capable of imaging in a wide visual field of 180 degrees, for example. Or, a camera capable of the so-called fish-eye imaging of 360 degrees may be used and an image of a range in the line-of-sight direction of the user may be cut out from a fish-eye imaged image. The location where the camera 61 is provided is not limited to the end part ER of the image display unit 20, but may be a location corresponding to the glabella of the user or the end part EL of the image display unit 20.

The image display unit 20 further has a connection unit 40 for connecting the image display unit 20 to the control unit 10. The connection unit 40 includes a main body cord 48 connected to the control unit 10, a right cord 42 and a left cord 44 bifurcated from the main body cord 48, and a coupling member 46 provided at the bifurcation point. The right cord 42 is inserted into a casing of the right holding part 21 from an end part AP in the extension direction of the right holding part 21 and connected to the right display drive part 22. Similarly, the left cord 44 is inserted into a casing of the left holding part 23 from an end part AP in the extension direction of the left holding part 23 and connected to the left display drive part 24. The coupling member 46 has a jack for connection of an earphone plug 30. From the earphone plug 30, a right earphone 32 and a left earphone 34 extend.

The image display unit 20 and the control unit 10 perform transmission of various signals via the connection unit 40. Connectors (not shown) fitted in each other are respectively provided in the end part in the main body cord 48 opposite to the coupling member 46 and in the control unit 10. By fit/unfit of the connector of the main body cord 43 and the connector of the control unit 10, the control unit 10 and the image display unit 20 are connected or disconnected. For example, metal cables and optical fibers may be employed for the right cord 42, the left cord 44, and the main body cord 48.

The control unit 10 is a device for controlling the head mounted display 100. The control unit 10 includes a lighting part 12, a touch pad 14, an arrow key 16, and a power switch 18. The lighting part 12 notifies the user of the operation status (e.g., ON/OFF of power or the like) of the head mounted display 100 by its emission state. As the lighting part 12, for example, an LED (Light Emitting Diode) may be used. The touch pad 14 detects a touch operation on the operation surface of the touch pad 14 and outputs a signal in response to the detected operation. As the touch pad 14, various touch pads of electrostatic type, pressure detection type, and optical type may be employed. The touch pad 14 displays various switches, which will be described later, and outputs control signals in response to the user operations of the switches. FIG. 1 shows an imaging start switch by the camera 61, a switch for determination of necessity of preview display, which will be described later, in a menu. The switch display is turned on at predetermined times including the time when the device power is turned on or at predetermined motions by the user, e.g., single touch of the touch pad 14 or a motion of quickly and vertically moving the control unit 10. The arrow key 16 detects a press operation for the key corresponding to up, down, right, and left and outputs a signal in response to the detected operation. The power switch 18 detects a slide operation of the switch, and thereby, switches the state of power of the head mounted display 100.

FIG. 2 is a block diagram functionally showing a configuration of the head mounted display 100. The control unit 10 has an input information acquisition part 110, a memory part 120, a power source 130, a wireless communication part 132, a GPS module 134, a CPU 140, an interface 100, and transmission parts (Tx) 51 and 52, and the respective parts are connected to one another via a bus (not shown).

The input information acquisition part 110 acquires signals in response to the operation input to, e.g., the touch pad 14, the arrow key 16, the power switch 18, etc. The memory part 120 includes a ROM, a RAM, a DRAM, a hard disc, or the like. The memory part 120 stores CG (computer graphics) of icons or the like displayed in a virtual image VI, which will be described later, a display status setting table when the camera imaged image is displayed in preview as a virtual image as will be described later, etc. The power source 130 supplies power to the respective units of the head mounted display 100. As the power source 130, for example, a secondary cell may be used. The wireless communication part 132 performs wireless communication with another device according to a predetermined wireless communications standard including wireless LAN and Bluetooth.

The CPU 140 reads and executes computer programs stored in the memory part 120, and thereby, functions as an operating system (OS) 150, the image processing part 160, a sound processing part 170, a display control part 190, a preview control part 141, and a generation part 143.

The image processing part 160 generates signals based on contents (images) input via the interface ISO. In the embodiment, the imaged image imaged by the camera 61 is one of the contents. Further, the image processing part 160 supplies the generated signals to the image display unit 20 via the connection unit 40. The signals for supplying to the image display unit 20 are different between the cases of an analog format and a digital format. In the case of the analog format, the image processing part 160 generates and transmits clock signals PCLK, vertical synchronizing signals VSync, horizontal synchronizing signals HSync, and image data Data. Specifically, the image processing part 160 acquires image signals contained in the contents. In the case of video, for example, the acquired image signals are generally analog signals including 30 frame images per second. The image processing part 160 separates synchronizing signals including the vertical synchronizing signals VSync and the horizontal synchronizing signals HSync from the acquired image signals, and generates clock signals PCLK using a PLL circuit or the like in response to the periods of the signals. The image processing part 160 converts the analog image signals from which the synchronizing signals have been separated into digital image signals using an A/D converter circuit or the like. The image processing part 160 stores the converted digital image signals in a DRAM within the memory part 120 as image data Data of RGB data with respect to each frame. On the other hand, in the case of the digital format, the image processing part 160 generates and transmits clock signals PCLK and image data Data. Specifically, in the case where the contents are in the digital format, the clock signals PCLK are output in synchronization with the image signals, and generation of the vertical synchronizing signals VSync and the horizontal synchronizing signals HSync and the A/D-conversion of the analog image signals are unnecessary. Note that the image processing part 160 may execute image processing such as resolution conversion processing, various kinds of tone correction processing including adjustment of brightness and saturation, keystone correction processing, or the like on the image data Data stored in the memory part 120.

The image processing part 160 respectively transmits the generated clock signals PCLK, vertical synchronizing signals VSync, horizontal synchronizing signals HSync, and the image data Data stored in the DRAM within the memory part 120 via the transmission parts 51, 52. Note that the image data Data transmitted via the transmission part 51 is also referred to as “right eye image data Data 1” and the image data Data transmitted via the transmission part 52 is also referred to as “left eye image data Data 2”. The transmission parts 51, 52 function as transceivers for serial transmission between the control unit 10 and the image display unit 20.

The display control part ISO generates control signals for controlling the right display drive part 22 and the left display drive part 24. Specifically, the display control part 190 individually controls drive ON/OFF of the right LCD 241 by a right LCD control part 211, drive ON/OFF of a right backlight 221 by a right backlight control part 201, drive ON/OFF of the left LCD 242 by a left LCD control part 212, drive ON/OFF of a left backlight 222 by a left backlight control part 202, etc. with the control signals, and thereby, controls the respective generation and output of image lights by the right display drive part 22 and the left display drive part 24. For example, the display control part ISO may allow both the right display drive part 22 and the left display drive part 24 to generate image lights, allow only one of the parts to generate image light, or allow both the right display drive part 22 and the left display drive part 24 not to generate image lights. Further, the display control part 190 respectively transmits the control signals for the right LCD control part 211 and the left LCD control part 212 via the transmission parts 51 and 52. Furthermore, the display control part 190 respectively transmits the control signals for the right backlight control part 201 and the left backlight control part 202. Note that the display control part 190 constructs “virtual image formation processing unit” in this application in cooperation with the image processing part 160, the preview control part 141, and the generation part 143, and executes virtual image formation processing necessary for virtual image formation in the image display unit 20.

The preview control part 141 generates a preview image, which will be described later, based on a user operation of the display status setting table displayed on the touch pad 14 of the control unit 10 in the input information acquisition part 110, and outputs the image signals to the generation part 143. In this regard, when an imaged image is input from the camera 61, the preview control part 141 also generates a preview image for the imaged image of the camera 61 for preview display. The generation part 143 forms image data when a virtual image is displayed in the image display unit 20 to be described later based on the CG stored in the memory part 120 and the image signals from the preview control part 141, and outputs the data to the image display unit 20. In this manner, the generation part 143 constructs “virtual image formation processing unit” in this application in cooperation with the image processing part 160, the preview control part 141, and the display control part 190.

The sound processing part 170 acquires sound signals contained in the contents, amplifies the acquired sound signals, and supplies the signals to a speaker (not shown) of the right earphone 32 and a speaker (not shown) of the left earphone 34 connected to the coupling member 46. Note that, for example, in the case where the Dolby (registered trademark) system is employed, processing on the sound signals is performed and different sounds at the varied frequencies or the like are respectively output from the right earphone 32 and left earphone 34.

The interface 180 is an interface for connecting various external devices OA as supply sources of contents to the control unit 10. The external devices OA include a personal computer PC, a ceil phone terminal, a game terminal, etc., for example. As the interface 160, for example, a USB interface, a micro USE interface, an interface for memory card, or the like may be used.

The image display unit 20 includes the right display drive part 22, the left display drive part 24, the right light guide plate 261 as the right optical image display part 26, the left light guide plate 262 as the left optical image display part 28, the camera 61, and a nine-axis sensor 66.

The nine-axis sensor 66 is a motion sensor that detects acceleration (three axes), angular velocities (three axes), and geomagnetism (three axes). The nine-axis sensor 66 is provided in the image display unit 20, and thus, when the image display unit 20 is worn on the head of the user, functions as a motion detection part that detects the motion of the head of the user. Here, the motion of the head includes the speed, acceleration, angular velocity, orientation, and change in orientation of the head.

The right display drive part 22 includes a reception part (Rx) 53, the right backlight (BL) control part 201 and the right backlight (BL) 221 that function as a light source, the right LCD control part 211 and the right LCD 241 that function as a display device, and the right projection optical system 251. Note that the right backlight control part 201, the right LCD control part 211, the right backlight 221, and the right LCD 241 are also collectively referred to as “image light generation part”.

The reception part 53 functions as a receiver for serial transmission between the control unit 10 and the image display unit 20. The right backlight control part 201 drives the right backlight 221 based on the input control signal. The right backlight 221 is a light emitter such as an LED or electroluminescence (EL), for example. The right LCD control part 211 drives the right LCD 241 based on the clock signal PCLK, the vertical synchronizing signal VSync, the horizontal synchronizing signal HSync, and the right-eye image data Data 1 input via the reception part 53. The right LCD 241 is a transmissive liquid crystal panel in which a plurality of pixels are arranged in a matrix.

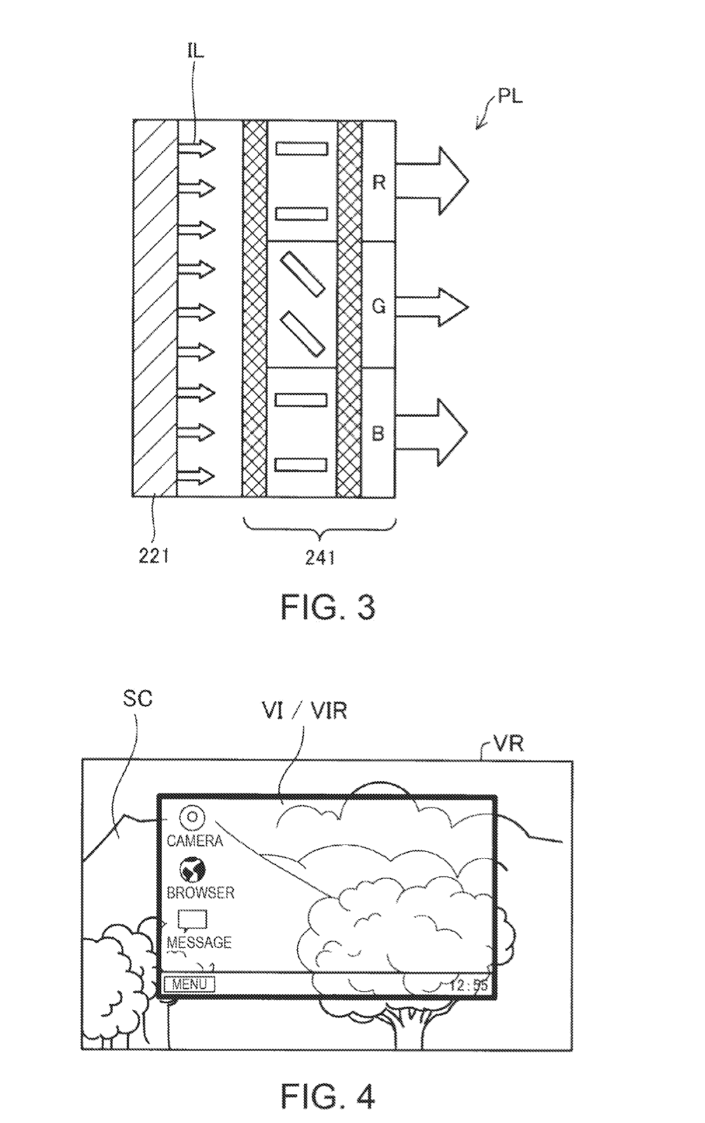

FIG. 3 is an explanatory diagram showing image lights output by the image light generation part in the right display drive part 22. The right LCD 241 drives the liquid crystal in the respective pixel positions arranged in the matrix to change the transmittance of the light transmitted through the right LCD 241, and thereby, modulates illumination light radiated from the right backlight 221 into effective image light representing an image. Note that the backlight system is employed in the embodiment, however, image light may be output using the front light system or the reflection system.

The right protection optical system 251 includes a collimator lens that brings the image light output from the right LCD 241 into parallelized luminous fluxes. The right light guide plate 261 as the right optical image display part 26 guides the image light output from the right projection optical system 251 to the right eye RE of the user while reflecting the light along a predetermined optical path. The optical image display parts may use any system as long as a virtual image is formed in front of the eyes of the user using image light. For example, a diffraction grating or a semi-transmissive reflection film may be used.

The left display drive part 24 for the left eye LE has the similar configuration to that of the right display drive part 22. That is, the left display drive part 24 includes a reception part (Rx) 54, the left backlight (BL) control part 202 and the left backlight (BL) 222 that function as a light source, the left LCD control part 212 and the left LCD 242 that function as a display device, and the left projection optical system 252. The right display drive part 22 and the left display drive part 24 are paired and the respective parts of the left display drive part 24 have the same configurations and functions as the respective parts explained in the right display drive part 22, and their explanation will be omitted.

FIG. 4 is an explanatory diagram showing an example of a virtual image formed to be recognized by the user in a generation part 143, a preview control part 141, etc. In the above described manner, the image lights guided to the eyes of the user of the head mounted display 100 form images on retinas of the user, and thereby, the user may visually recognize a virtual image VI. As shown in FIG. 4, the virtual image VI is displayed within a visual range VR of the user in the head mounted display 100, and the virtual image VI contains various kinds of CG including an icon representing the drive status of the camera 61. Further, of the visual range VR of the user, regarding a part in which the virtual image VI is displayed, the user visually recognizes the virtual image VI of the optical image display parts and an outside scenery SC through the virtual image VI behind the virtual image VI. Of the visual range VR of the user, regarding other parts than the part in which the virtual image VI is displayed, the user may directly see the outside scenery SC through the optical image display parts. In the embodiment, in addition to various kinds of CG described above, a frame showing the virtual image display range VIE as the display range of the virtual image VI is processed to be visually recognized as a virtual image.

The image data for displaying the virtual image VI superposed on the outside scenery SC is generated by image data formation for virtual image display performed in the generation part 143 of the head mounted display 100. Then, the image data generated in the generation part 143 is transmitted to the right LCD control part 211 etc., and the virtual image VI is displayed in a front range of the user. At the image data generation, the generation part 143 generates different right-eye image data Data 1 and left-eye image data Data 2 for display of the virtual image VI superimposed on the outside scenery SC. As a result, the virtual image VI is displayed on the outside scenery SC.

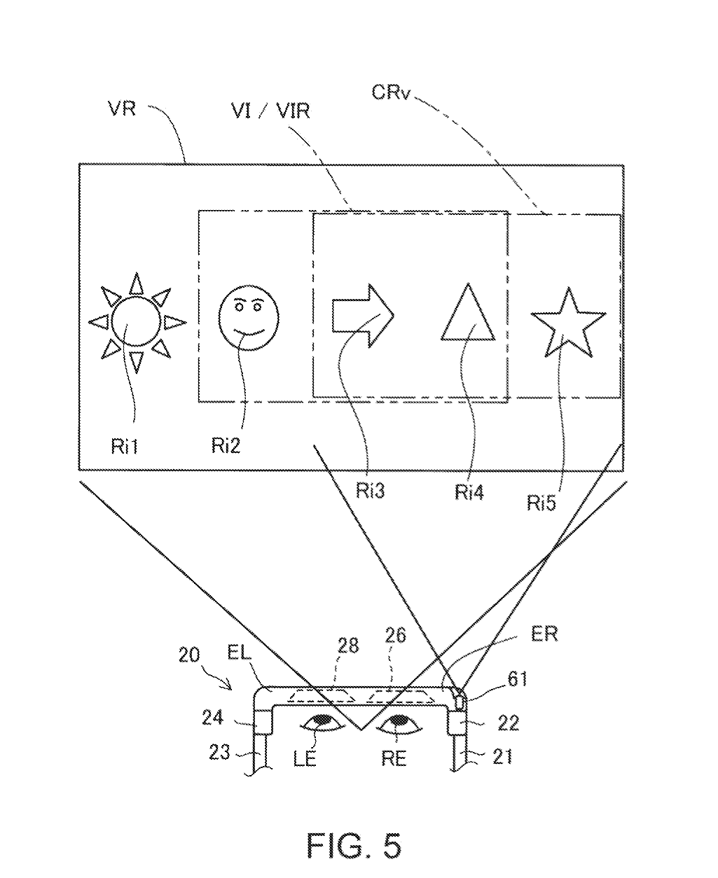

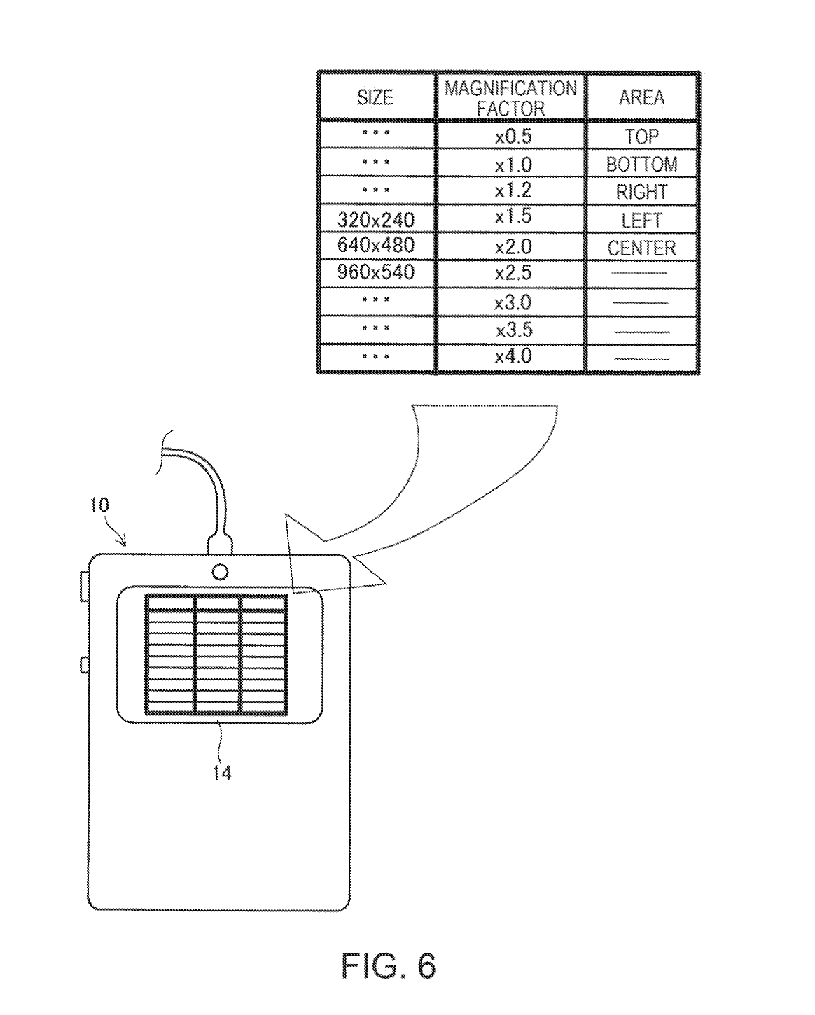

Here, a relationship among the visual range VR of the user and the imaging range CRv of the camera 61 and the virtual image display range VIR when the imaged image is displayed as the virtual image VI is explained. FIG. 5 is an explanatory diagram schematically showing the relationship among the visual range VR of the user and the imaging range CRv of the camera 61 and the virtual image display range VIR. As shown in the drawing, when real images Ri1 to Ri5 are horizontally and equally arranged and contained in the visual range VR of the riser, the camera 61 is located in the end part ER of the image display unit 20 worn by the user, and the imaging range CRv is a partial range at the right side of the visual range VR and the camera 61 images the real images Ri3 to Ri5. The virtual image VI (virtual images Vi3 to Vi5) as the imaged image of the camera 61 is provided as a preview image to be described later in a partial range of the virtual image display range VIR that occupies the nearly center part of the visual range VR. The display location of the preview image containing the virtual images VI3 to Vi5 may be set to one of upper, lower, center parts of the left area of the virtual image display range VIR, upper, lower, center parts of the right area, or upper, lower, center parts of the center area and the display range is set by the user operation as will be described later. Further, the display size of the preview image may be adjusted at multiple stages and set through a user operation. In addition, enlargement and reduction of the preview image may be set and the scaling factor is set through a user operation. FIG. 6 is an explanatory diagram showing settings of a display size of a preview image containing a virtual image VI corresponding to an imaged image of the camera 61 etc.

The control unit 10 displays the display status setting table on the touch pad 14 as shown in FIG. 6 at a predetermined time when the device power is turned on or the like, or in response to a predetermined motion by the user, e.g., double touch of the touch pad 14 or a motion of quickly moving the control unit 10 in the horizontal directions. The display status setting table contains pluralities of setting options for the display size of the preview image, the scaling factor, and the display location in the virtual image display range VIR in a menu format. Thereby, the user sees the display status setting table and selects and sets the display size of the preview image, the scaling factor, and the display location in the virtual image display range VIR as described above. The setting signal is output to the generation part 143 and the preview control part 141 and used for image data processing necessary for display of the preview image. The display status of the preview image is set by the user as needed through the display of the display status setting table on the touch pad 14.

The user visually recognizes the outside scenery SC through the preview image containing the virtual image VI (virtual images Vi3 to Vi5) obtained in the generation part 143. As below, an imaged image actually imaged by the camera 61 and displayed as a virtual image VI of the preview image in the virtual image display range VIR is referred to as “camera preview PrV” and processing with respect to the camera preview will be explained.

### A-2. Camera Preview Processing

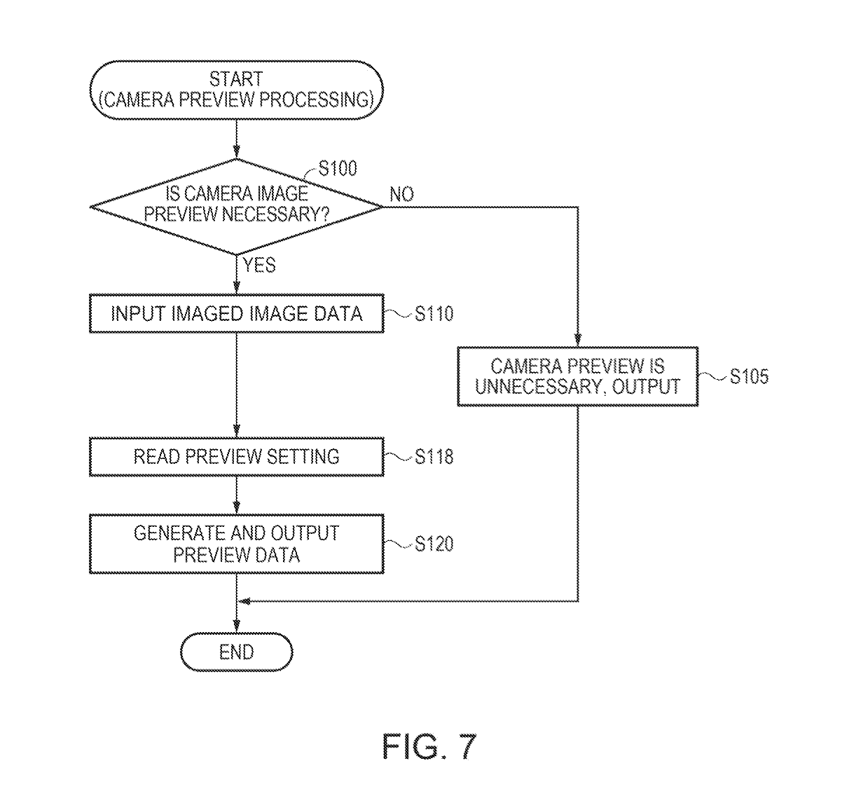

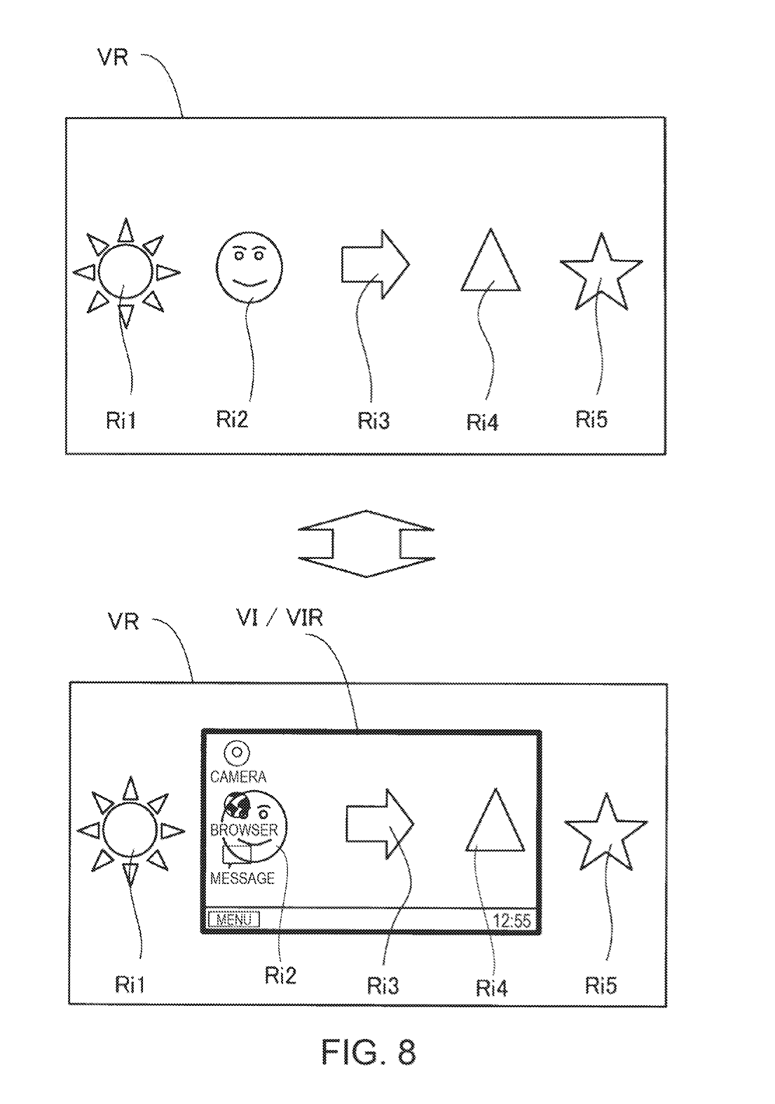

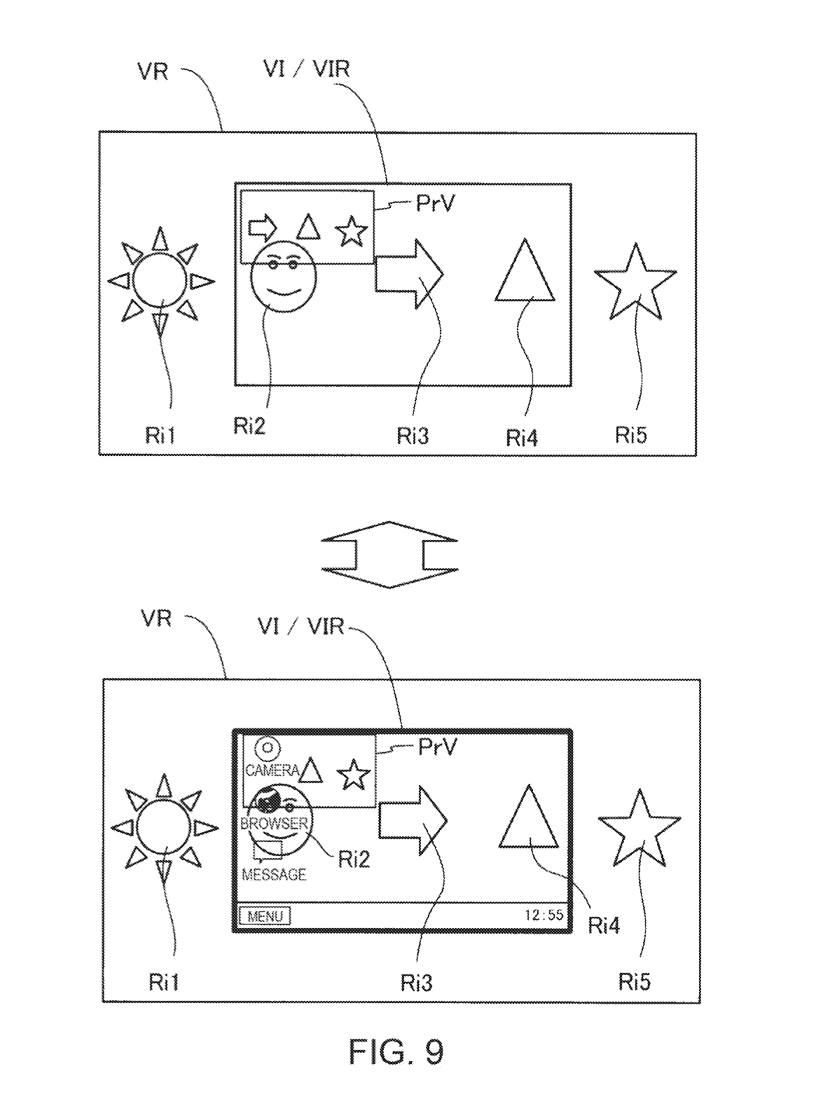

FIG. 7 is an explanatory diagram for explanation of an outline of the camera preview processing executed in the control unit 10 including the image processing part 160, the display control part 190, etc., FIG. 8 is an explanatory diagram showing schematic display formats when a camera preview PrV is unnecessary, and FIG. 9 is an explanatory diagram schematically showing examples of display formats when the camera preview PrV is performed. The camera preview processing is repeatedly executed while the camera 61 continues imaging, and the control unit 10 first determines necessity of camera preview PrV of displaying an imaged image imaged by the camera 61 as a virtual image VI in the virtual image display range VIR (step S100). In this case, imaging by the camera 61 is started with a predetermined operation (imaging start switch operation) on the touch pad 14, a head motion of the user wearing the head mounted display 100, e.g., a continuous vertical motion of the head, or the like as a trigger. Further, regarding the necessity of camera preview PrV, specifically, if the camera preview PrV is necessary, another predetermined operation (preview execution operation) on the touch pad 14, another head motion of the user, e.g., a continuous horizontal motion of the head, or the like is necessary. The control unit 10 waits for the operation or the head behavior, and determines the necessity of camera preview at step S100. More specifically, the control unit 10 displays a preview execution switch in addition to the imaging start switch or after operation of the switch on the touch pad 14, and waits for a preview execution switch operation by the user. Then, when the user operation of the switch is performed, the control unit determines that the camera preview display is necessary. In addition, the control unit 10 monitors the head behavior of the user based on the sensor output from the nine-axis sensor 66 and, if the head behavior of the user coincides with the horizontal motion of the head, determines that the camera preview display is necessary.

The control unit 10 determines the necessity of camera preview PrV at step S100 depending on presence of the preview execution operation and the predetermined head motion and, if determining that the camera preview PrV is unnecessary, outputs a control signal indicating that the camera preview is unnecessary to the image display unit 20 (step S105), and stops this routine. If the determination that the camera preview is unnecessary is made at step S100, the image display unit 20 receives the control signal indicating that the camera preview is unnecessary, as shown in FIG. 8, takes one of an upper format in which the virtual image VI containing the virtual image display range VIR is not displayed and a lower format in which the range frame of the virtual image display range VIR and various kinds of CG are displayed as the virtual image VI, and does not include the camera preview PrV in these images. Which of the formats is taken may be specified by a dip switch (not shown) or the like or predetermined by a predetermined user operation. In the embodiment, regarding the necessity of camera preview, the initial setting that the camera preview is unnecessary is made, and, when the camera 61 is turned on and starts imaging by the user operation, if there is no preview execution operation or predetermined head motion, the unit takes one of the formats in FIG. 8 through the denial determination at step S100.

On the other hand, if the determination that the camera preview is necessary is made at step S100, the control unit 10 inputs imaged image data of the camera 61 (step S110) and reads preview settings (step S118) by the user operation using the display status setting table (see FIG. 6) on the touch pad 14. In the embodiment, the display status setting of the preview image is made by the user as needed as described above, and thereby, the display status of the camera, preview PrV shown in FIG. 9 is that the display location is in the upper left area of the virtual image display range VIR, the display size is e.g., 320×240, and the display scaling factor is ×0.5. Therefore, the generation part 143 of the control unit 10 cooperates with the preview control part 141 to generate image data for display of the virtual image VI (virtual image data) from the input imaged image data, outputs the generated image data to the image display unit 20 so that the camera preview PrV may be displayed in the virtual image in the virtual image display range VIR in the set display status (step S120), and stops the routine. Thereby, the image display unit 20 displays the virtual image VI containing the imaged image imaged by the camera 61 as the camera preview PrV in the virtual image display range VIR within the visual range VR of the user, and allows the user to visually recognize the virtual image VI. For display of the virtual image VI containing the imaged image imaged by the camera 61, the camera preview PrV containing the virtual images Vi3 to Vi5 in the example shown in FIG. 5, as shown in FIG. 9, the image display unit 20 takes one of an upper format in which the camera preview PrV containing the virtual images Vi3 to Vi5 is displayed with the range frame of the virtual image display range VIR in the display position set in the virtual image display range VIR and a lower format in which various kinds of CG including an icon representing the drive status of the camera 61 are displayed with the range frame of the virtual image display range VIR in addition to the camera preview PrV containing the virtual images Vi3 to Vi5. Which of the formats is taken may be specified by a dip switch (not shown) or the like or predetermined by a predetermined user operation. For display of the virtual image VI containing the imaged image imaged by the camera 61 as the camera preview PrV, in the embodiment, the display period of the camera preview PrV is limited to a predetermined period, e.g., a period of several seconds to ten and several seconds. In this case, whether the display of the camera preview PrV is limited in a predetermined time or continuously performed may be specified by a dip switch (not shown) or the like or predetermined by a predetermined user operation.

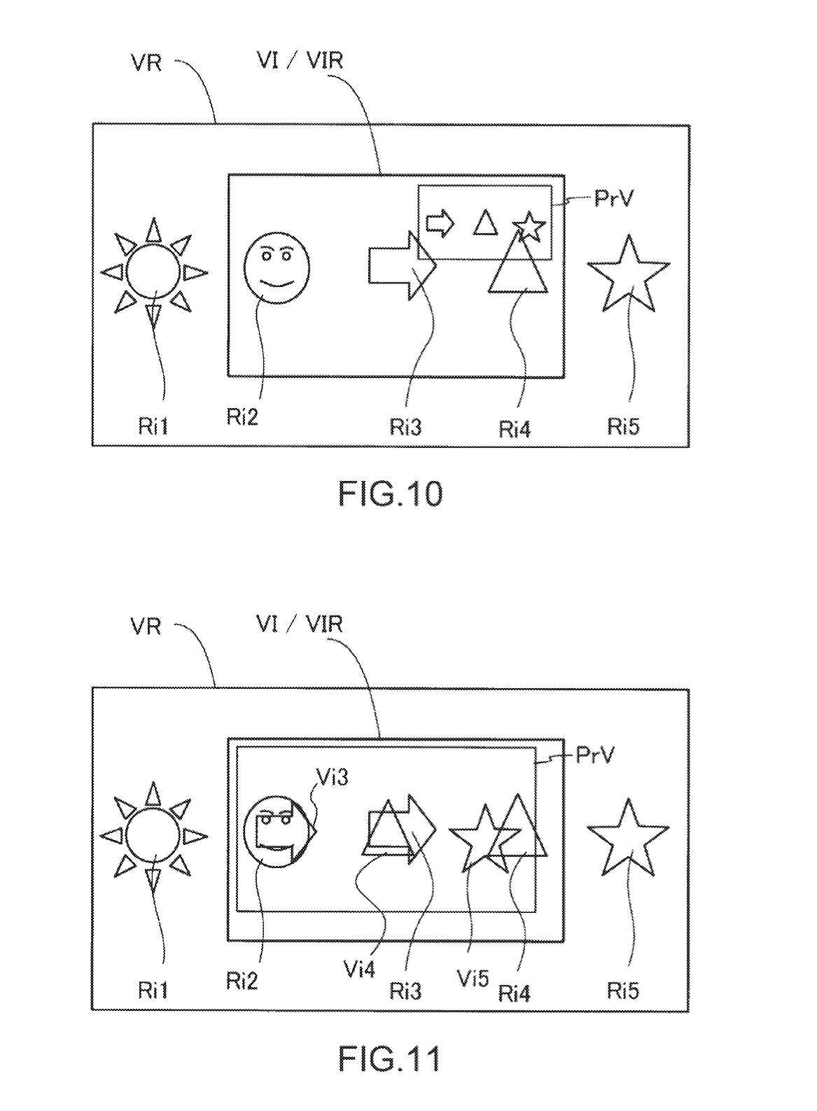

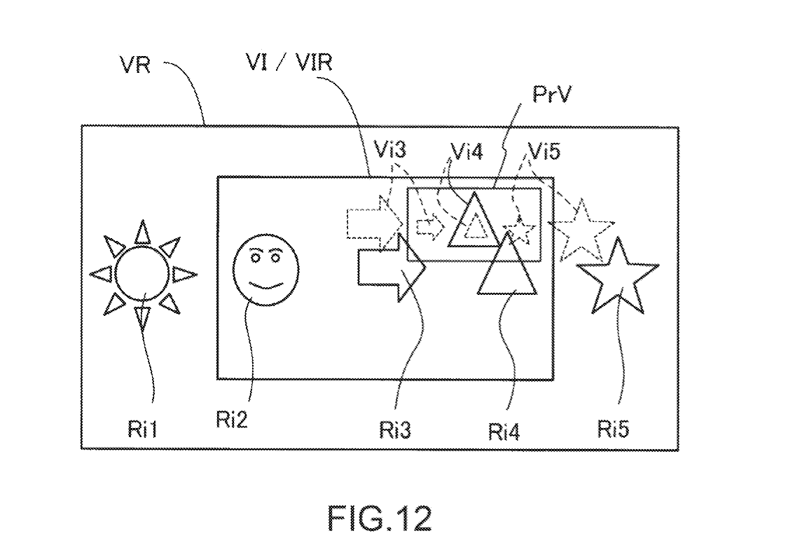

FIG. 10 is an explanatory diagram schematically showing a display format when the display location of the camera preview PrV is set in an upper right area of the virtual image display range VIR by a user operation, FIG. 11 is an explanatory diagram schematically showing a display format when the display location of the camera preview PrV is set in an upper left area of the virtual image display range VIR and a display size is set to 960×540 by a user operation, and FIG. 12 is an explanatory diagram schematically showing a display format when the display location of the camera preview PrV is set in an upper right area of the virtual image display range VIR and the display scaling factor is set to 2.0 by a user operation. As shown in the respective drawings, the control unit 10 virtually displays the camera preview PrV in the virtual image display range VIR in the generation part 143 and the preview control part 141 in response to the display status settings of the preview image read at step S118. In the enlarged display of FIG. 12, the virtual images Vi3 to Vi5 corresponding to the real images Ri3 to Ri5 are enlarged at the set magnification factor and displayed, and thereby, in the camera preview PrV in the set display size, only the virtual image Vi4 is enlarged and displayed and the enlarged virtual image Vi3 and virtual image Vi5 are not displayed because they are out of the display area of the camera preview PrV.

The head mounted display 100 of the embodiment having the above described configuration generates image data for display of the virtual image VI superimposed on the outside scenery SC in the preview control part 141 and the generation part 143 for the user to visually recognize the virtual image VI superimposed on the outside scenery SC so that the virtual image VI may be displayed in the front range of the user using the generated image data. Further, for virtual display of the camera preview PrV containing the virtual images Vi3 to Vi5 corresponding to the imaged image imaged by the camera 61 in the virtual image display range VIR, the head mounted display 100 of the embodiment forms image data necessary for virtual display of the camera preview PrV (step S120) in response to the display status set in the display status setting table (step S118), and virtually displays the camera preview PrV in the virtual image display range VIR in the set display status. The head mounted display 100 of the embodiment may set different display statuses as shown in FIGS. 9 to 12 as their examples, and thereby, may display the camera preview PrV with the imaged image of the camera 61 as the virtual image in the image display unit 20 in various statuses through data processing for virtual image formation in response to the respective display statuses. For example, in the camera preview PrV shown in FIG. 12, the virtual image Vi4 corresponding to the real image Ri4 may be provided in a display status in which the virtual image matches with the real image Ri4 as the real outside scenery as close as possible, and the virtual image Vi4 corresponding to the real image Ri4 may be displayed close to the real image Ri4 as the real outside scenery and provided in a display status in which they may be compared. For example, when the real image Ri4 is a QR code, the QR code as the real image Ri4 seen by the user and the virtual image Vi4 imaged by the camera 61 and virtually displayed may be compared, and thereby, code reading accuracy by the camera 61 is improved and alignment with the OR code is easier. As a result, according to the head mounted display 100 of the embodiment, in the head mounted display 100 with the camera 61, the feeling of strangeness when the imaged image of the camera 61 is provided as the virtual image may be relaxed and the convenience may be improved.

The head mounted display 100 of the embodiment may set one of the display size of the camera preview PrV, the display location of the camera preview PrV in the virtual image display range VIR, and the scaling factor (magnification factor) of the image contained in the camera preview PrV as shown in FIG. 6. Therefore, according to the head mounted display 100 of the embodiment, the display status in which the imaged image of the camera 61 is virtually displayed as the camera preview PrV in the image display unit 20 may be further diversified, and the feeling of strangeness due to mismatch with the real outside scenery may be further relaxed and the convenience may be improved.

The head mounted display 100 of the embodiment sets the display status of the camera preview PrV by the user operation of the display status setting table shown in FIG. 6. The user performs the predetermined operation necessary for virtual display of the camera preview PrV, and the user predicts the mismatch between the virtual image VI (virtual images Vi3 to Vi5) contained in the camera preview PrV and the real images Ri3 to Ri5 or the like. In addition, the head mounted display 100 of the embodiment may variously set the display status of the camera preview PrV through the operation of the user to whom the imaged image of the camera 61 is provided as the camera preview PrV as the virtual display. Therefore, according to the head mounted display 100 of the embodiment, the feeling of strangeness due to mismatch with the real outside scenery may be further relaxed through the user operation and the convenience may be improved.

As described above, for displaying the virtual image Vi4 corresponding to the real image Ri4 close to the real image Ri4 as the real outside scenery so that they may be compared, it is not necessary for the head mounted display 100 of the embodiment to drive-control the camera 61 so that the optical axis of the camera 61 may be aligned with the line of sight of the user. Therefore, according to the head mounted display 100 of the embodiment, it is not necessary to specially use a mechanical configuration for driving the camera optical axis or a processing device for drive-control of the configuration. Thus, according to the head mounted display 100 of the embodiment, versatility for virtual display of the imaged image imaged by the camera 61 as the camera preview PrV may be improved and the cost may be reduced.

For not virtually displaying the imaged image imaged by the camera 61 as the camera preview PrV, the head mounted display 100 of the embodiment may display and provide various kinds of CG in the virtual image display range VIR to the user as shown in the lower part of FIG. 8. Therefore, according to the head mounted display 100 of the embodiment, the user may recognize that imaging is being performed by the camera 61 through the display of the virtual image display range VIR and the CG, and the convenience is preserved. Note that, in the format in the lower part of FIG. 8, the range frame of the virtual image display range VIR may not be displayed, but only various kinds of CG including an icon representing the drive status of the camera 61 or red blinking may be displayed. In this manner, the user may recognize that imaging is being performed by the camera 61 though the icon display and the red blinking display, and the convenience is preserved. In place of the red blinking or at the same time with the red blinking, the user may be informed of the imaging being performed by the camera using sound.

### B. Modified Examples

In the above described embodiment, a part of the configuration implemented by hardware may be replaced by software, or, conversely, a part of the configuration implemented by software may be replaced by hardware. In addition, the following modifications may be made.

### Modified Example 1

In the above described embodiment, the configuration of the head mounted display is exemplified. However, the configuration of the head mounted display may be arbitrarily determined without departing from the scope of the invention. For example, addition, deletion, conversion, etc. of the respective configuration parts may be made.

The assignment of the component elements to the control unit and the image display unit in the above described embodiment is just an example, and various forms may be employed. For example, the forms are as follows: (i) a form in which the processing functions of the CPU, the memory, etc. are provided in the control unit and only the display function is provided in the image display unit; (ii) a form in which the processing functions of the CPU, the memory, etc. are provided in both the control unit and the image display unit; (iii) a form in which the control unit and the image display unit are integrated (e.g., a form that functions as a spectacle-shaped wearable computer with the image display unit containing the control unit); (iv) a form in which a smartphone or a portable game machine is used in place of the control unit; and (v) a form in which the control unit and the image display unit are adapted to be capable of wireless communication and wireless power supply and the connection unit (cord) is removed.

In the above described embodiment, for convenience of explanation, the control unit includes the transmission parts and the image display unit includes the reception parts. However, both the transmission parts and the reception parts in the above described embodiment have functions that enable two-way communication and may function as transmission and reception parts. Further, for example, the control unit shown in FIG. 2 is connected to the image display unit via a wired signal transmission path. However, the control unit and the image display unit may be connected by connection via a wireless signal transmission path of wireless LAN, infrared communication, Bluetooth (registered trademark), or the like.

For example, the configurations of the control unit and the image display unit shown in FIG. 2 may be arbitrarily changed. Specifically, for example, another operation interface of an operation stick or the like may be provided in the control unit 10. Or, the control unit 10 may be adapted to be correctable to a device such as a keyboard or mouse and receive input from the keyboard, mouse, or the like. Or, for example, in addition to the operation input using the touch pad and the arrow key, operation input using a foot switch (a switch operated by the foot of the user) may be acquired. If the operation input by the foot switch or the line of sight may be acquired, even in a work for which the user is difficult to release the hand, the input information acquisition part may acquire the operation input from the user.

For example, the head mounted display is the binocular-type transmissive head mounted display, however, the display may be a monocular-type head mounted display.

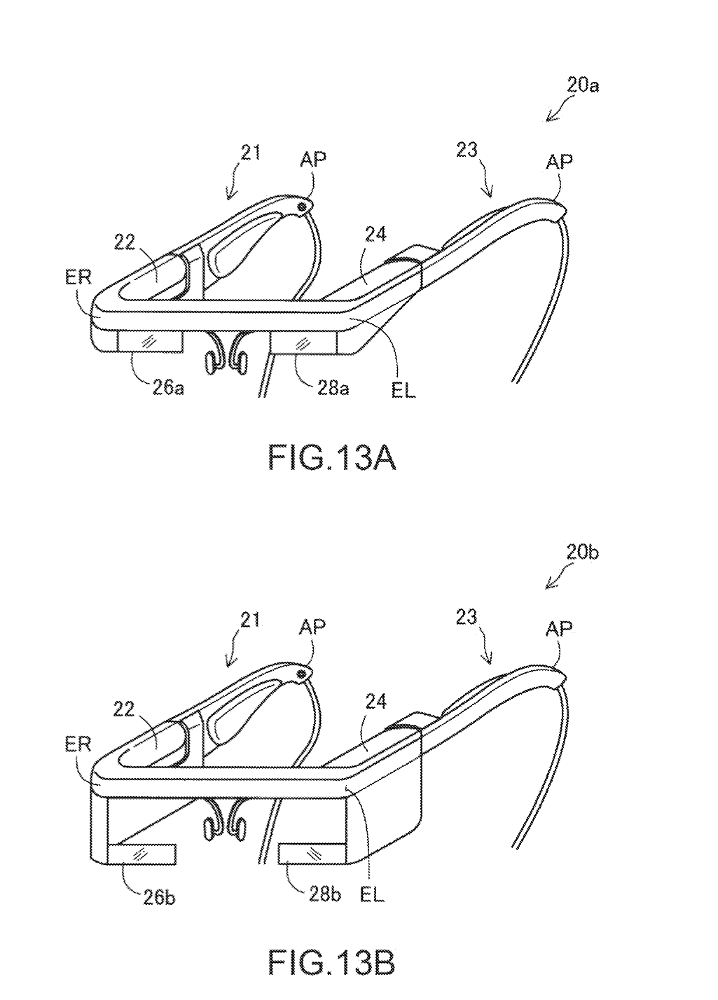

FIGS. 13A and 13B are explanatory diagrams showing outer configurations of head mounted displays in modified examples. In the case of the example of FIG. 13A, the difference from the head mounted display 100 shown in FIG. 1 is that an image display unit 20a includes a right optical image display part 26a in place of the right optical image display part 26 and a left optical image display part 28a in place of the left optical image display part 28. The right optical image display part 26a is formed to be smaller than the optical members of the above described embodiment, and provided in the obliquely upper part of the right eye of the user when the head mounted display is worn. Similarly, the left optical image display part 28a is formed to be smaller than the optical members of the first embodiment, and provided in the obliquely upper part of the left eye of the user when the head mounted display is worn. In the case of the example of FIG. 13B, the difference from the head mounted display 100 shown in FIG. 1 is that an image display unit 20b includes a right optical image display part 26b in place of the right optical image display part 26 and a left optical image display part 28b in place of the left optical image display part 28. The right optical image display part 26b is formed to be smaller than the optical members of the first embodiment, and provided in the obliquely lower part of the right eye of the user when the head mounted display is worn. The left optical image display part 28b is formed to be smaller than the optical members of the first embodiment, and provided in the obliquely lower part of the left eye of the user when the head mounted display is worn. As described above, it is only necessary that the optical image display parts are provided near the eyes of the user. Further, the sizes of the optical members forming the optical image display parts may be arbitrary, and a head mounted display in which the optical image display parts cover only parts of the user's eyes, in other words, the optical image display parts do not completely cover the user's eyes may be implemented.

For example, the functional parts of the image processing part, the display control part, the preview control part, the generation part, the sound processing part, etc. are implemented by the CPU developing and executing the computer program stored in a ROM or a hard disc in a RAM. However, the functional parts may be formed using an ASIC (Application Specific Integrated Circuit) designed for implementation of the functions.

For example, in the above described embodiments, the head mounted display has the image display unit worn as spectacles, however, the image display unit may be a transmissive fiat display device (liquid crystal display device, plasma display device, organic EL display device, or the like). Also, in this case, the connection between the control unit and the image display unit may be connection via a wired signal transmission path or connection via a wireless signal transmission path. According to the configuration, the control unit may be used as a remote for a typical flat display device.

Further, as the image display unit, in place of the image display unit worn like spectacles, for example, an image display unit having another shape such as an image display unit worn like a hat may be employed. Or, ear-fit-type or headband-type earphones may be employed or omitted. Further, the display may be formed as a head-up display (HUD) mounted on a vehicle of an automobile, an airplane, or the like, for example. Furthermore, for example, the display may be formed as a head mounted display build in a body protector including a hardhat.

For example, in the above described embodiments, the secondary cell is used as the power source, however, not only the secondary cell but also various batteries may be used for the power source. For example, a primary cell, a fuel cell, a solar cell, a thermal cell, or the like may be used.

For example, in the above described embodiments, the image light generation part is formed using the backlight, the backlight control part, the LCD, and the LCD control part. However, the above described forms are just examples. The image light generation part may include other configuration parts for implementation of another system with the configuration parts or in place of the configuration parts. For example, the image light generation part may include an organic SL (Organic Electro-Luminescence) display and an organic EL control part. Or, for example, a digital micromirror device, or the like may be used for the image generation part, in place of the LCD. In addition, for example, the invention may be applied to a laser retina projection-type head mounted display device.

### Other Modified Examples

An AR processing part that executes processing for implementation of augmented reality (hereinafter, also referred to as “augmented reality processing”) may be provided in the head mounted display 100. The augmented reality processing means, at virtual display of the virtual image display range VIR and various kinds of CG shown in FIG. 4, for example, generation of image data representing additionally presented information for augmentation of the outside scenery SC perceived by the user and virtual display using the data. Then, the image data generated in the AR processing part is transmitted to the right LCD control part 211 etc., and the virtual image VI is displayed in a front range of the user. Note that “augmentation of outside scenery SC” means augmentation of the outside scenery SC as a real world seen by the user by adding, deleting, enhancing, and attenuating information to the reality environment seen by the user, i.e., the outside scenery SC. At the augmented reality processing for image data generation, the AR processing part generates different right-eye image data Data 1 and left-eye image data Data 2 for fusion of the additionally presented information with the outside scenery SC. “Fusion of additionally presented information with outside scenery” means display of the virtual image VI that gives a feeling to the user that the additionally presented information exists in a location at a predetermined distance from the user of the outside scenery SC actually seen by the user.

For example, assuming that the virtual image VI visually recognized by the user in FIG. 4 is an apple, image data representing the apple is generated by the augmented reality processing of the AR processing part as image data superimposed on the real road contained in the outside scenery SC, and an image based on the generated image data is displayed as the virtual image VI. Thereby, the user may feel as if there were the apple on the road on which there is nothing in reality. The AR processing part generates the data for the right eye and the left eye for displaying the virtual image VI shown in FIG. 4 and the virtual image VI of the apple at the predetermined distances from the user on the real outside scenery SC by augmented reality processing, and outputs the data, if image data of another content from the external device OA is subjected to the augmented reality processing in place of the image data representing the apple, image data for displaying the content based on the image data as a virtual image VI is generated and an image based on the generated image (content) is displayed as the virtual image VI. Thereby, the user may visually recognize the content as the virtual image VI superimposed on the outside scenery contained in the visual range VR. The AR processing part generates the image data for the right eye and the left eye for displaying the virtual image VI shown in FIG. 4 and the virtual image VI of the content at the predetermined distances from the user on the real outside scenery SC by augmented reality processing, and outputs the data in cooperation with the display control part 190. If the augmented reality processing is not executed by the AR processing part, a frame showing a virtual image display range VIR as a display range of the virtual image VI shown in FIG. 4 and various kinds of CG including the icon representing the drive status of the camera 61 contained in the virtual image display range VIR are displayed as the virtual image VI by the preview control part 141 and the generation part 143 in the image display unit 20 as described above.

The AR processing part may implement the augmented reality processing by pattern matching of the outside scenery image in front of the user acquired by the camera using a pixel parallactic angle. Specifically, the image display unit includes a right-eye camera and a left-eye camera. The right-eye camera is provided in a location of the image display unit corresponding to the right eye of the user and may image the outside scenery in the anterior direction of the image display unit. The left-eye camera is provided in a location of the image display unit corresponding to the left eye of the user and may image the outside scenery in the anterior direction of the image display unit. The AR processing part may obtain an amount of difference between an object contained in an image imaged by the right-eye camera (an object for which additionally presented information is displayed in the vicinity) and an object contained in an image imaged by the left-eye camera, and determine “target distance” as a display location of the virtual image VI in the augmented reality processing using the amount of difference and the pixel parallactic angle.

The AR processing part may execute the augmented reality processing with respect the contents provided from the external device OA only when a predetermined condition is satisfied. For example, a configuration that can detect the line-of-sight direction of the user may be provided in the image display unit, and the AR processing part may execute the augmented reality processing only when the detected line-of-sight direction satisfies at least one of the following conditions.
The line-of-sight direction is within a range of viewing angles of about 200° horizontally and about 125° vertically (e.g., 75° downward, 50° upward).
The line-of-sight direction is within a range of about 30° horizontally and about 20° vertically as an effective field of view advantageous in information capacity.
The line-of-sight direction is within a range of about 60° to 90° horizontally and about 45° to 70° vertically as a stable field of fixation in which a point of gaze is quickly and stably seen.
The line-of-sight direction is within a range from about 20° horizontally at which induction of a sense of self-motion induced by an image (vection) starts to occur to about 110° at which the sense of self-motion is saturated.

In the embodiment, a horizontal line of red or the like may be displayed at the center of the virtual image display range VIR by the image display unit 20. Thus displayed horizontal line may be used for alignment when the camera 61 is used for information reading for a barcode and a QR code. Therefore, in the display format when the camera preview is unnecessary, the display format of the increased display size shown in FIG. 11, and the enlarged display format shown in FIG. 12, the horizontal line of red or the like may be displayed as a virtual image. In this manner, the camera position is adjusted without virtual display of the camera preview PrV containing an imaged image imaged by the camera 61 (in this case, the barcode or the QR code) so that the horizontal line may coincide with the barcode or the QR code and the camera position is adjusted so that the horizontal line may coincide with the barcode or the QR code in the camera preview PrV, and thereby, information may be reliably read by the camera 61 and the convenience is improved.

In the embodiments, the camera 61 is attached to the image display unit 20, however, the camera 61 may be provided separately from the image display unit 20 and imaging in the line-of-sight direction of the user may be performed by the separate camera 61. In this case, the separate camera 61 may be connected to the control unit 10 via a signal line such as a USB cable. In the separate camera 61, imaging in the line-of-sight direction of the user may be performed and imaging in a different imaging direction from the line-of-sight direction of the user may be performed. A camera image imaged in the different imaging direction from the line-of-sight direction of the user may be completely different from a real outside scenery visually recognized by the user, and the above described feeling of strangeness due to mismatch may be significant. Therefore, when the camera performs imaging in a different imaging direction from the line-of-sight direction of the user, a determination that the camera preview display is unnecessary may be made and the process may be moved to step S105. Further, when the user dares to desire imaging in a different imaging direction from the line-of-sight direction of the user, some switch may be displayed on the touch pad 14 and a determination that the camera preview display is necessary may be made by the switch operation even when the camera 61 performs imaging in the different imaging direction from the line-of-sight direction of the user.

In the embodiments, at step S100, the necessity of camera preview display is determined in response to the user operation of the preview execution switch displayed on the touch pad 14 (see FIG. 1) and the head behavior of the user, however, not limited to that. For example, a still mode switch for setting imaging by the camera 61 to still image imaging and a video mode switch for setting video imaging may be displayed on the touch pad 14 and the necessity of camera preview display may be determined by the user operation of one of the mode switches. Specifically, if there is a user operation of the still mode switch, the determination that the camera preview display is necessary is made and the process moves to step S110. The camera image after the operation of the still mode switch is a still image and mismatches with the outside scenery visually recognized by the user, however, the user knows the feeling of strangeness due to mismatch with the real outside scenery because the user desires the still image. Therefore, even in the case where the camera preview display is performed after the user operation of the still mode switch, the feeling of strangeness due to mismatch with the real outside scenery is harder to be given to the user, and the feeling of strangeness is relaxed. With the camera preview PrV display in the still image, data processing load as a virtual image VI may be reduced. When the camera preview PrV display in the still image is performed with a monochrome image, data processing load may be further reduced. Alternatively, if there is a user operation of the video mode switch, the determination that the camera preview display is unnecessary is made, and the process moves to step S105 and the camera preview PrV is not performed. Generally, in video display, a predetermined processing time is taken for data processing to its virtual image VI, however, the camera preview PrV is not performed in the video mode and the processing load may be reduced.

The invention is not limited to the above described embodiments, examples, and modified examples, but may be implemented in various configurations without departing from the scope thereof. For example, the technical features in the embodiments, the examples, and the modified examples corresponding to the technical features in the respective forms described in “SUMMARY” may be appropriately replaced or combined in order to solve part or all of the above described problems or achieve part or all of the above described advantages. Further, the technical features may be appropriately deleted unless they are described as essential features in the specification.

The entire disclosure of Japanese Patent Application No. 2013-259740, filed Dec. 17, 2013 is expressly incorporated by reference herein.

What is claimed is:

1. A head mounted display device that enables visual recognition of a virtual image superimposed on an outside scenery, comprising:
an image display unit that forms and displays the virtual image to be visually recognized by a user;
a virtual image formation processing unit that executes virtual image formation processing in the image display unit;
a camera that can perform imaging in a line-of-sight direction of the user; and
a preview setting unit that sets an image display status when an imaged image imaged by the camera is virtually displayed as a preview image in the image display unit.

2. The head mounted display device according to claim 1, wherein the preview setting unit sets at least one of a display sire of the preview image, a display location of the preview image in a virtual image display range, and a scaling factor when the imaged image is used as the preview image.

3. The head mounted display device according to claim 1, wherein the preview setting unit waits for settings of the image display status by the user.

4. The head mounted display device according to claim 3, further comprising an option setting operation unit displaying a plurality of setting options with respect to each image display status and operated by the user for selection of the displayed setting options,
wherein the preview setting unit sets the image display status by a user operation of the option setting operation unit.

5. The head mounted display device according to claim 3, further comprising a display setting operation unit operated by the user when one of a setting of displaying the preview image and a setting of not displaying the image is determined,
wherein the preview setting unit sets the image display status by a user operation of the option setting operation unit when the setting of displaying the preview image is made by a user operation of the display setting operation unit.

6. The head mounted display device according to claim 3, further comprising a display setting unit that monitors a behavior of a head of the user, and mates the setting of displaying the preview image when the user mates a predetermined head behavior,
wherein the preview setting unit sets the image display status by a user operation of the option setting operation unit when the display setting unit makes the setting of displaying the preview image.

7. The head mounted display device according to claim 3, further comprising a mode switching unit for the user to switch an imaging status by the camera to one of a still image imaging mode and a video imaging mode,
wherein the preview setting unit sets the image display status by a user operation of the option setting operation unit when the mode switching unit switches to the still image imaging mode.

8. The head mounted display device according to claim 1, wherein the virtual image formation processing unit executes the virtual image formation processing so that the preview image may be displayed on the image display unit over a predetermined time.
